(19) United States
(12) Patent Application Publication
(10) Pub. No.: US 2025/0233719 A1
(43) Pub. Date: Jul. 17, 2025

(54) COMMUNICATION SYSTEM, COMMUNICATION METHOD AND COMMUNICATION PROGRAM

(71) Applicant: NEC Corporation, Minato-ku, Tokyo (JP)

(72) Inventor: Shoma OTSUKA, Tokyo (JP)

(73) Assignee: NEC Corporation, Minato-ku, Tokyo (JP)

(21) Appl. No.: 18/848,988

(22) PCT Filed: Mar. 24, 2022
(86) PCT No.: PCT/JP2022/014014

§ 371 Date: Sep. 20, 2024

(51) Int. Cl. H04L 5/00

(52) U.S. Cl. CPC H04L 5/0098; H04L 5/0053

(57) ABSTRACT

Transmitting from a radio wave transmitting station, while transmitting a dummy signal wave of a predetermined frequency band, a communication signal wave including information whose content is not desired to be intercepted at a frequency included in the predetermined frequency band. Receiving, at a radio wave receiving station, complexed waves including the dummy signal wave and the communication signal wave and extracting the communication signal wave by removing the dummy signal wave from the complexed waves. Herein, the radio wave transmitting station transmits the communication signal wave during a partial time frame within a time band of transmitting the dummy signal wave.

### FIELD

The present invention relates to a communication system, a communication method and a communication program, particularly a communication system, a communication method and a communication program that communicates information whose content is not desired to be intercepted while concealing it.

### BACKGROUND

For example, there is a technology for radio communication while keeping secret state of information whose content is not desired to be intercepted as disclosed in Patent Literature 1 (PTL 1).

### CITATION LIST

### Patent Literature

PTL 1: Japanese Patent Kokai Publication No. JP2000-278194A

### SUMMARY

### Technical Problem

The following analysis is made from an aspect of the present invention. Herein, disclosure of the document cited in the Citation List is incorporated in the present application by reference thereto.

Conventional technologies including PTL 1 focus on modifying communication information itself, such as encrypting the information whose content is not desired to be intercepted. However, there is a problem that such encryption becomes useless once decryption technology is developed.

Accordingly, it is a purpose of the present invention to provide a secret communication technology not relying on encryption.

### Solution to Problem

According to a first aspect of the present invention, there is provided a communication system, comprising:
a radio wave transmitting station that transmits, while transmitting a dummy signal wave of a predetermined frequency band, a communication signal wave including information whose content is not desired to be intercepted at a frequency included in the predetermined frequency band, and
a radio wave receiving station that receives complexed waves including the dummy signal wave and the communication signal wave and extracts the communication signal wave by removing the dummy signal wave from the complexed waves.

According to a second aspect of the present invention, there is provided a communication method, comprising:
a step of transmitting from a radio wave transmitting station, while transmitting a dummy signal wave of a predetermined frequency band, a communication signal wave including information whose content is not desired to be intercepted at a frequency included in the predetermined frequency band, and
a step of receiving, at a radio wave receiving station, complexed waves including the dummy signal wave and the communication signal wave and extracting the communication signal wave by removing the dummy signal wave from the complexed waves.

According to a third aspect of the present invention, there is provided a communication program,
causing a computer as a radio wave transmitting station to execute a process of transmitting, while transmitting a dummy signal wave of a predetermined frequency band, a communication signal wave including information whose content is not desired to be intercepted at a frequency included in the predetermined frequency band, and
causing a computer as a radio wave receiving station to execute a process of receiving complexed waves including the dummy signal wave and the communication signal wave and extracting the communication signal wave by removing the dummy signal wave from the complexed waves.

### Advantageous Effects of Invention

According to each aspect of the present invention, there are provided a communication system, a communication method and a communication program that contribute to communicate information whose content is not desired to be intercepted while concealing it.

### BRIEF DESCRIPTION OF THE DRAWINGS

FIG. 1 is an explanatory view of one outline of the present invention.

FIG. 2 is a diagram showing a communication system 10 of an example embodiment 1.

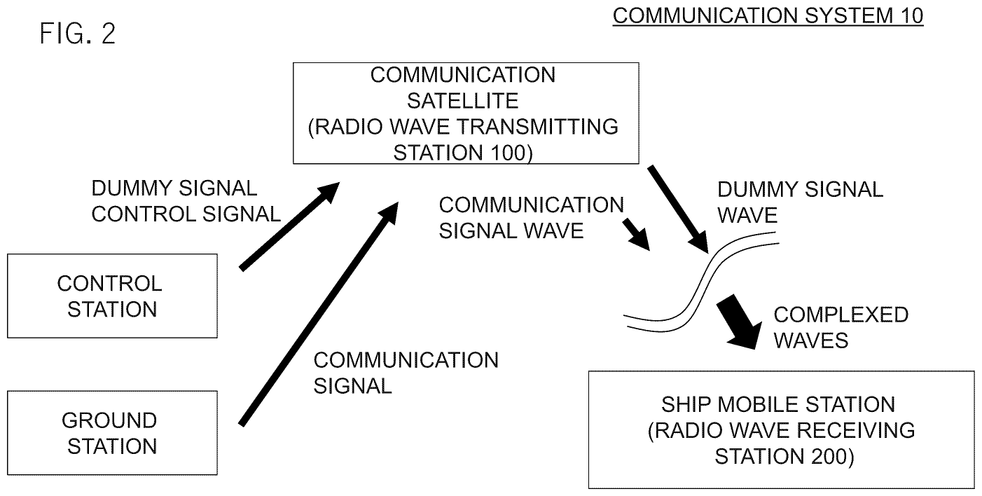

FIG. 3 is a block diagram showing a configuration of a communication satellite (radio wave transmitting station 100).

FIG. 4 is a block diagram showing a configuration of a ship mobile station (a radio wave receiving station 200).

FIG. 5 is a flowchart diagram showing processes in the communication system 10.

FIG. 6 is a diagram showing an example of a computer as a radio wave transmitting station 100.

FIG. 7 is a diagram showing an example of a computer as the radio wave receiving station 200.

### EXAMPLE EMBODIMENTS

A preferable example embodiment which may be realized by the present invention is explained in detail with reference to the drawings. Herein, reference signs in the following description are expediently attached to each element as an explanatory aid for understanding, but not for limitation of the present invention to an illustrated configuration. In addition, connection lines between blocks in each figure include both of bidirectional and one directional. One way arrow schematically indicates a flow of main signal (data), thus does not exclude bidirectional. In addition, in a circuit diagram, a block diagram, an inner configuration diagram, a connection diagram, etc., illustrated in the present disclosure, input/output ends of each of connection lines respectively have input/output ports, but explicit indications thereof are omitted. The same is applied to input/output interfaces, too.

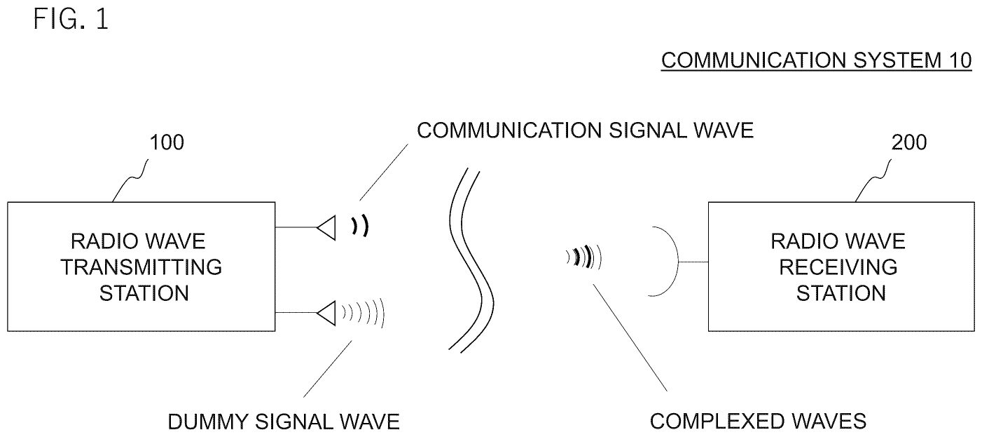

First, one outline of the present invention is explained. A communication system 10 of the present invention comprises a radio wave transmitting station 100 and a radio wave receiving station 200, as illustrated in FIG. 1. The radio wave transmitting station 100 transmits, while transmitting dummy signal wave of a predetermined frequency band, communication signal wave including information whose content is not desired to be intercepted at a frequency included in the predetermined frequency band. The radio wave receiving station 200 receives complexed waves including the dummy signal wave and the communication signal wave and extracts the communication signal wave by removing the dummy signal wave from the complexed waves. Herein, the radio wave transmitting station 100 may transmit the communication signal wave during a partial time frame within a time band of transmitting the dummy signal wave.

In such communication system 10, since the communication signal wave is mixed in the dummy signal wave, it is impossible to know what frequency the communication signal wave has and when the communication signal wave is transmitted. As a result, the communication system 10 may perform communication while concealing information whose content is not desired to be intercepted.

### Example Embodiment 1

In an example embodiment 1, the communication system 10 described in the above outline is explained while referring to one concrete example. A communication system 10 of the example embodiment 1 comprises a communication satellite as the radio wave transmitting station 100, a ship mobile station as the radio wave receiving station 200, a control station and a ground station.

The control station transmits a control signal for controlling orbit and posture of the communication satellite and a dummy signal as a source of the dummy signal wave toward the communication satellite. The ground station transmits communication signal as a source of the communication signal wave to the communication satellite. The control station and the ground station are exemplified by a satellite control station and a communication station, thus detail explanation thereof is omitted. Herein, the dummy signal transmitted from the control station and the communication signal transmitted from the ground station are assumed to be uninterceptable.

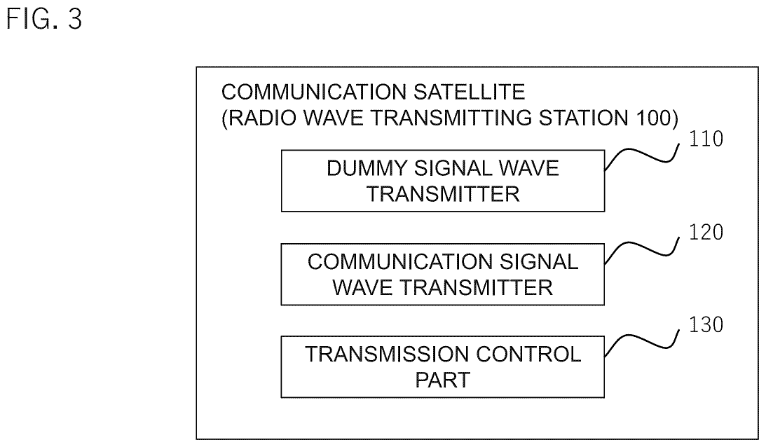

The communication satellite (radio wave transmitting station 100) comprises a dummy signal wave transmitter 110, a communication signal wave transmitter 120 and a transmission control part 130, as illustrated in FIG. 3. The communication satellite may further comprise an antenna for receiving signals from the control station and the ground station, an amplifier for amplifying received signals, a converter for converting the received signals to radio waves, a storage medium, etc. They are not different from configurations of a satellite for TV broadcasting, thus explanations thereof are omitted.

The dummy signal wave transmitter 110 is an antenna for transmitting the dummy signal wave of a predetermined frequency band. The communication signal wave transmitter 120 is an antenna for transmitting the communication signal wave. The transmission control part 130 generates the dummy signal wave and the communication signal wave from received signals from the control station and the ground station and transmits them via the dummy signal wave transmitter 110 and the communication signal wave transmitter 120. Concretely, the transmission control part 130 transmits the communication signal wave at a frequency included in a frequency band of the dummy signal wave during a partial time frame within a time band of transmitting the dummy signal wave. Particularly, the transmission control part 130 transmits the dummy signal wave while changing contents of the dummy signal wave and/or frequencies of the dummy signal wave in accordance with a concealing rule.

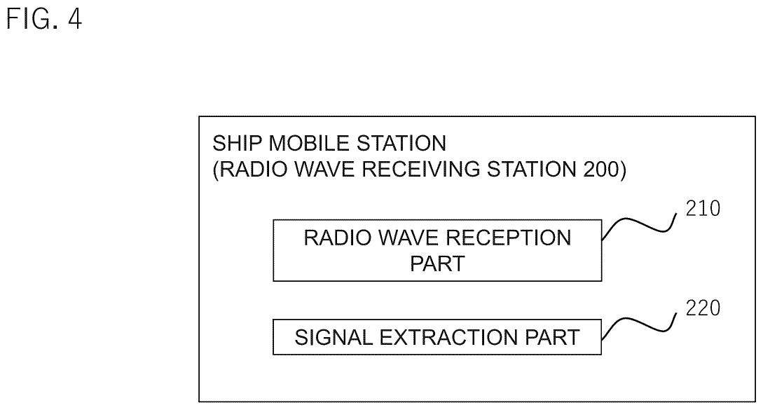

The ship mobile station (radio wave receiving station 200) comprises a radio wave reception part 210 and a signal extraction part 220 as illustrated in FIG. 4. The ship mobile station may further comprise a wave splitter, an amplifier, a frequency mixer, a modulator, a noise canceller, a demodulator, an output device, a storage medium, etc. They are not different from configurations of a general radio wave receiving station, thus explanations thereof are omitted. Herein, the ship mobile station is not limited to a ship, and may be a mobile station such as a vehicle as well as a fixed station that does not move.

The radio wave reception part 210 is an antenna for receiving complexed waves including the dummy signal wave and the communication signal wave. The signal extraction part 220 extracts the communication signal wave by removing the dummy signal wave from the complexed waves. Particularly, the radio wave reception part 210 extracts the communication signal wave by removing the dummy signal wave from the complexed waves based on a concealing rule previously taught. Herein, the communication signal wave may be extracted by adding an inverse phase wave of the dummy signal wave to the complexed waves, or by using Successive Interference Cancellation (SIC) technology after digitizing the complexed waves.

The dummy signal wave, the communication signal wave and the complexed waves are explained conceptually as follows.

The dummy signal wave is a radio wave that is assumed to be intercepted by a third party. The communication signal wave is a radio wave including information whose content is not desired to be intercepted by the third party. The complexed waves are radio waves including the dummy signal wave and the communication signal wave, which are transmitted individually. Herein, a fundamental concept of the present invention lies in concealing a tree (a leaf) as the communication signal wave in a forest as the dummy signal wave(s).

For example, it is assumed that the communication satellite transmits the communication signal wave at a particular frequency, while transmitting the dummy signal waves at a plurality of frequencies. Ideally, the communication satellite transmits the dummy signal waves of a plurality of frequencies so that frequency band(s) used in satellite-based communication are entirely covered. Under such situation, the dummy signal waves and the communication signal wave interfere with each other, resulting in that the communication signal wave included in the complexed waves may be regarded as an encrypted state. Even if a third party intercepts the complexed waves, the third party is required to know what are the dummy signal waves in order to extract the communication signal wave from the complexed waves. Herein, the dummy signal waves are interfered by the communication signal wave and, yet more, the dummy signal waves are also interfered with one another, thus the dummy signal waves may be also regarded as encrypted states. Therefore, it is very difficult to recover (decrypt) the dummy signal waves of individual frequencies, i.e., to know what are the dummy signal waves, resulting in difficulty in interception of the communication signal wave. In addition, the third party can not know which frequency is used for the communication signal wave, the communication satellite may transmit a dummy signal wave of the same frequency as that of the communication signal wave so as to mislead the third party into thinking that only a dummy signal wave is being transmitted.

In addition, the communication satellite may transmit the dummy signal waves while changing frequencies thereof. Under such situation, the encryption becomes more complicated, since there are times (periods) of occurrence of interference of the radio waves with one another and times (periods) of no occurrence of the interference.

In addition, for example, it is assumed that the communication satellite transmits the communication signal wave only at a moment while 24 hours transmission of the dummy signal wave(s) including a meaning content. Under such situation, the communication signal wave looks like [pretends] a noise of the dummy signal wave. Further, if the meaning content of the dummy signal wave includes intentional noises, it is hardly known which noise be the communication signal wave. Of course, the dummy signal wave may not include the meaning content, preferably include no meaning content. The third party is forced to receive the dummy signal waves over almost throughout 24 hours, and receive the complexed waves including the communication signal wave only at a moment. Herein, since the communication signal wave looks like the noise, the communication signal wave is to be removed as a noise when a standard noise canceller is used. Therefore, the third party is forced to perform analysis what is the dummy signal wave under a situation that it is impossible to use noise cancelling, resulting in difficulty in interception of the communication signal wave.

The communication satellite may transmit the dummy signal waves while changing contents of the dummy signal waves and/or frequencies of the dummy signal waves in accordance with a concealing rule. Under such situation, analysis on what is the dummy signal wave becomes difficult, resulting in difficulty in interception of the communication signal wave.

Herein, the term “encryption” used in this context refers to a resulting encryption by virtue of interference of the radio waves one another, but not an encryption due to intentional modification of a communication signal. Therefore, it is impossible to prospect how the communication signal wave is encrypted even by a party who performs transmission of the communication signal wave, thus logical decryption analysis cannot be performed. However, it is also within a scope of the present invention to perform encryption of the communication signal itself.

On the other hand, the ship mobile station (radio wave receiving station 200) is possible to extract the communication signal wave by removing the dummy signal waves from the complexed waves because it has previously known the dummy signal waves and the concealing rule. Even if the dummy signal waves interfere with one another, there is no problem when the ship mobile station previously has known the post-interfered dummy signal waves. Herein, a noise canceller comprised in the ship mobile station is used for removing noises from the extracted signal wave.

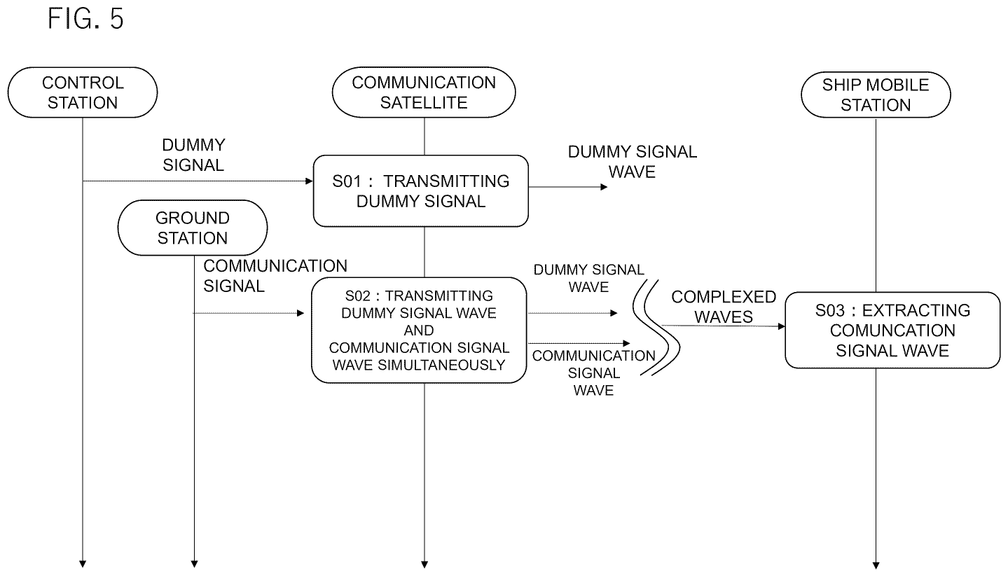

Next, one example of a process flow by the communication system 10 is explained. As illustrated in FIG. 5, the communication satellite receives a dummy signal from the control station, and generates the dummy signal wave(s) to transmit it (Step S01). At this timing, the ship mobile station is unnecessary to perform any processes even if it receives the dummy signal wave(s). Herein, the transmission of the dummy signal wave(s) is continued on or after Step S01.

After that, the communication satellite receives the communication signal from the ground station, and generates the communication signal wave to transmit it. The communication satellite performs transmission of the dummy signal wave(s) and transmission of the communication signal wave simultaneously, since it continuously transmits the dummy signal wave(s) (Step S02). The dummy signal wave(s) and the communication signal wave transmitted from the communication satellite are mixed with one another to become complexed waves. Herein, the transmission of the dummy signal wave(s) is also continued after Step S02.

The ship mobile station receives the complexed waves and removes the dummy signal wave(s) therefrom to extract the communication signal wave (Step S03).

As described above, the communication system 10 of the present invention may realize communication while concealing information whose content is not desired to be intercepted.

### Alternative Modes

Various alternative (modification) modes are explained as follows. For example, in a case where the radio wave transmitting station 100 is a communication satellite that broadcasts a radio wave onto the earth, the dummy signal wave may be broadcast onto a partial area within a broadcasting area of the communication signal wave. That is, the communication satellite may be broadcast the dummy signal wave in a narrowed manner onto only an area in which a third party who intends to intercept the communication signal wave is present. By virtue of narrowing broadcasting area of the dummy signal wave, the communication satellite may save electric power to be consumed and the like. Furthermore, in an area where the dummy signal wave is not broadcast, the communication signal wave may be directly received, thus extraction of the communication signal wave from the complexed waves is not required.

It is preferable that the dummy signal wave is transmitted from the radio wave transmitting station 100 so that a frequency band(s) used in communication is entirely covered. However, the dummy signal wave may be a frequency band that covers a frequency of at least the communication signal wave.

The radio wave transmitting station 100 may transmit the communication signal wave at a low power density while transmitting the dummy signal wave at a high power density. Explained in an aspect of SN ratio (signal-to-noise ratio), the present invention lies on a fundamental concept that the communication signal wave is an (intended) signal, whereas the dummy signal wave is a noise. However, the high power density dummy signal wave pretends to the (intended) signal, and the low power density signal wave pretends to the noise, thus the possibility of interception of the communication signal wave may be lowered.

The radio wave receiving station 200 may be synchronized with the dummy signal wave when it receives only the dummy signal wave. That is, the communication signal wave is received as the complexed waves in which the communication signal wave is mixed into the dummy signal wave, thus such synchronization with the dummy signal wave is meaningful for receiving the communication signal wave included in the complexed waves.

The dummy signal wave and the communication signal wave may be respectively transmitted from individual radio wave transmitting stations 100 (communication satellite). In other words, the communication system 10 may comprise a (first) radio wave transmitting station 100 equipped with the dummy signal wave transmitter 110 and a (second) radio wave transmitting station 100 equipped with the communication signal wave transmitter 120. In addition, a plurality of radio wave transmitting stations 100 (communication satellites) may respectively transmit the dummy signal waves of individual frequency bands.

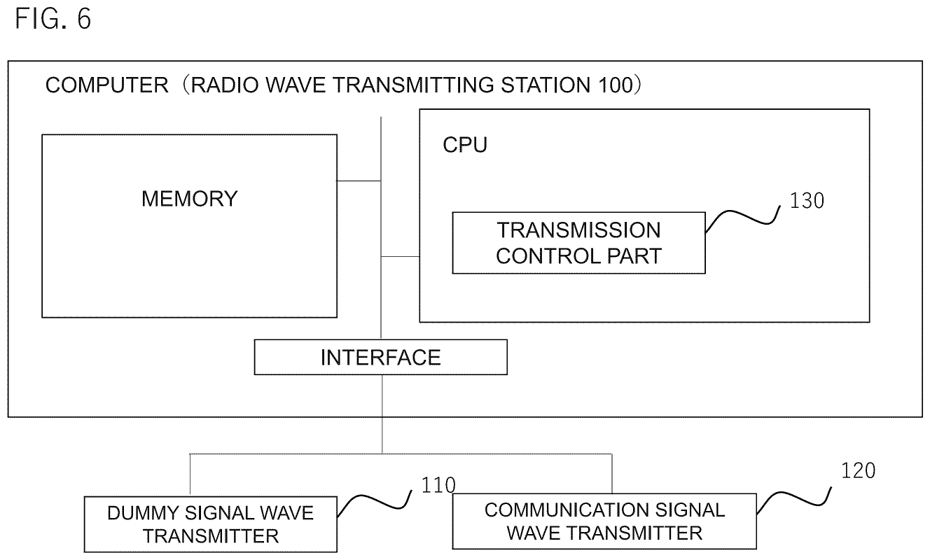

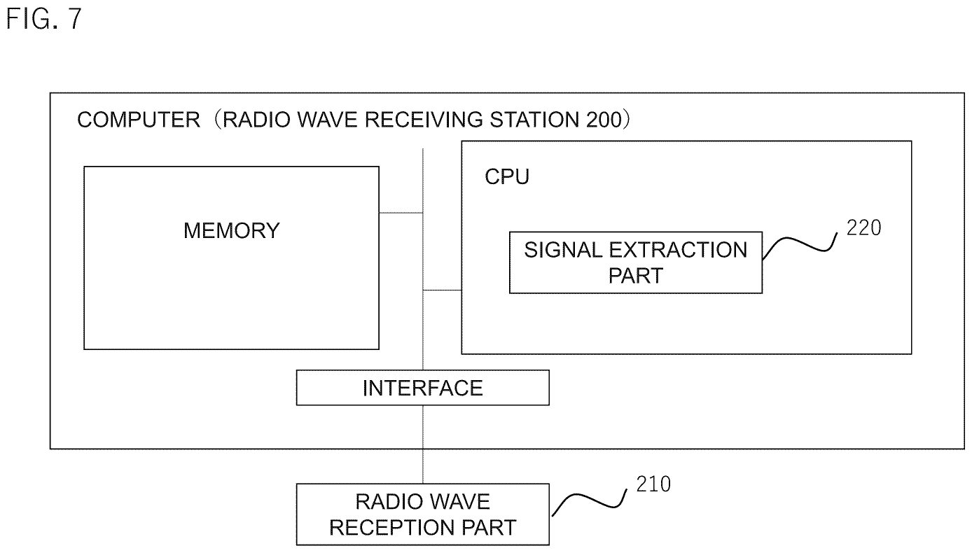

Furthermore, the present invention may be realized as a program that causes a computer to execute processes. That is, as illustrated in FIG. 6, a computer as the radio wave transmitting station 100 comprises a memory (ROM: Read Only Memory, RAM: Random Access Memory, cache memory, etc.), CPU: Central Processing Unit, and an interface. The interface is connected to the dummy signal wave transmitter 110 and the communication signal wave transmitter 120. CPU reads out a program from the memory to realize a processing module corresponding to the transmission control part 130. In addition, as illustrated in FIG. 7, a computer as the radio wave receiving station 200 comprises a memory, CPU and an interface, and is connected to the radio wave reception part 210 via the interface. CPU reads out a program from the memory to realize a processing module corresponding to the signal extraction part 220.

A part or entire of the example embodiment may be described as the following modes, but not limited thereto.

### Mode 1

A communication system, comprising
a radio wave transmitting station that transmits, while transmitting dummy signal wave of a predetermined frequency band, a communication signal wave including information whose content is not desired to be intercepted at a frequency included in the predetermined frequency band, and
a radio wave receiving station that receives complexed waves including the dummy signal wave and the communication signal wave and extracts the communication signal wave by removing the dummy signal wave from the complexed waves.

### Mode 2

The communication system according to Mode 1, wherein the radio wave transmitting station transmits the communication signal wave during a partial time frame within a time band of transmitting the dummy signal wave.

### Mode 3

The communication system according to Mode 1 or 2, wherein the radio wave transmitting station transmits the dummy signal wave while changing contents of the dummy signal wave and/or frequencies of the dummy signal wave in accordance with a concealing rule, and the radio wave receiving station extracts the communication signal wave by removing the dummy signal wave from the complexed waves based on the concealing rule previously taught.

### Mode 4

The communication system according to any one of Modes 1 to 3, wherein the radio wave transmitting station is a communication satellite that broadcasts radio waves onto the earth and casts the dummy signal wave onto a partial area within a broadcasting area of the communication signal wave.

### Mode 5

A communication method, comprising:
a step of transmitting from a radio wave transmitting station, while transmitting a dummy signal wave of a predetermined frequency band, a communication signal wave including information whose content is not desired to be intercepted at a frequency included in the predetermined frequency band, and
a step of receiving, at a radio wave receiving station, complexed waves including the dummy signal wave and the communication signal wave and extracting the communication signal wave by removing the dummy signal wave from the complexed waves.

### Mode 6

A communication program,
causing a computer as a radio wave transmitting station to execute a process of transmitting, while transmitting a dummy signal wave of a predetermined frequency band, a communication signal wave including information whose content is not desired to be intercepted at a frequency included in the predetermined frequency band, and
causing a computer as a radio wave receiving station to execute a process of receiving complexed waves including the dummy signal wave and the communication signal wave and extracting the communication signal wave by removing the dummy signal wave from the complexed waves.

Herein, it is assumed that disclosure of each of the above Patent Literature is incorporated in the present application and may be used as a base or a part of the present invention as necessary. The example embodiment(s) or example(s) may be modified or adjusted within the scope of the entire disclosure of the present invention, inclusive of claims, based on the basic technical concept of the invention. In addition, a variety of combinations or selections (including partial selection or non-selection) of disclosed variety elements (each element in each claim, each element in each example embodiment or each example, etc.) may be made within the claims of the present invention. That is, the present invention, of course, may cover a variety of modifications or corrections that may be made by those skilled in the art in accordance with the entire disclosure of the present invention, inclusive of claims, and the technical concept of the present invention. In particular, a numerical range described in the present application should be interpreted as specifically describing any numerical value or subrange included within said range, even if not explicitly described.

Furthermore, each of the disclosure in the above cited references shall be deemed to be included in the description of the present application, when necessary, as part of the description of the present invention, in whole or in part, in combination with the description of the present application, in accordance with the concept of the present invention.

### REFERENCE SIGNS LIST

10: communication system
100: radio wave transmitting station
110: dummy signal wave transmitter
120: communication signal wave transmitter
130: transmission control part
200: radio wave receiving station
210: radio wave reception part
220: signal extraction part

What is claimed is:

1. A communication system, comprising:
a radio wave transmitting station that transmits, while transmitting a dummy signal wave of a predetermined frequency band, a communication signal wave including information whose content is not desired to be intercepted at a frequency included in the predetermined frequency band, and
a radio wave receiving station that receives complexed waves including the dummy signal wave and the communication signal wave and extracts the communication signal wave by removing the dummy signal wave from the complexed waves.

2. The communication system according to claim 1, wherein
the radio wave transmitting station transmits the communication signal wave during a partial time frame within a time band of transmitting the dummy signal wave.

3. The communication system according to claim 1, wherein
the radio wave transmitting station transmits the dummy signal wave while changing contents of the dummy signal wave and/or frequencies of the dummy signal wave in accordance with a concealing rule, and
the radio wave receiving station extracts the communication signal wave by removing the dummy signal wave from the complexed waves based on the concealing rule previously taught.

4. The communication system according to claim 1, wherein
the radio wave transmitting station is a communication satellite that broadcasts radio waves onto the earth and casts the dummy signal wave onto a partial area within a broadcasting area of the communication signal wave.

5. A communication method, comprising:
transmitting from a radio wave transmitting station, while transmitting a dummy signal wave of a predetermined frequency band, a communication signal wave including information whose content is not desired to be intercepted at a frequency included in the predetermined frequency band, and
receiving, at a radio wave receiving station, complexed waves including the dummy signal wave and the communication signal wave and extracting the communication signal wave by removing the dummy signal wave from the complexed waves.

6. A non-transitory program recording medium, storing a communication program,
causing a computer as a radio wave transmitting station to execute a process of transmitting, while transmitting a dummy signal wave of a predetermined frequency band, a communication signal wave including information whose content is not desired to be intercepted at a frequency included in the predetermined frequency band, and
causing a computer as a radio wave receiving station to execute a process of receiving complexed waves including the dummy signal wave and the communication signal wave and extracting the communication signal wave by removing the dummy signal wave from the complexed waves.

7. The communication method according to claim 5, wherein the communication method further comprises:
transmitting the communication signal wave during a partial time frame within a time band of transmitting the dummy signal wave.

8. The communication method according to claim 5, wherein the communication method further comprises:
transmitting the dummy signal wave while changing contents of the dummy signal wave and/or frequencies of the dummy signal wave in accordance with a concealing rule, and
extracting the communication signal wave by removing the dummy signal wave from the complexed waves based on the concealing rule previously taught.

9. The communication method according to claim 5, wherein the communication method further comprises:
from a communication satellite, broadcasting radio waves onto the earth and casts the dummy signal wave onto a partial area within a broadcasting area of the communication signal wave.

10. The non-transitory program recording medium according to claim 6, wherein the communication program causes the computer as the radio wave transmitting station to transmit the communication signal wave during a partial time frame within a time band of transmitting the dummy signal wave.

11. The non-transitory program recording medium according to claim 6, wherein the communication program
causes the computer as the radio wave transmitting station to transmit the dummy signal wave while changing contents of the dummy signal wave and/or frequencies of the dummy signal wave in accordance with a concealing rule, and
causes the computer as the radio wave receiving station to extract the communication signal wave by removing the dummy signal wave from the complexed waves based on the concealing rule previously taught.

12. The non-transitory program recording medium according to claim 6, wherein the radio wave transmitting station is a communication satellite that broadcasts radio waves onto the earth and casts the dummy signal wave onto a partial area within a broadcasting area of the communication signal wave.
